(19) United States
(12) Patent Application Publication
(10) Pub. No.: US 2008/0135359 A1
(43) Pub. Date: Jun. 12, 2008

(54) BRAKE ROTOR WITH CERAMIC MATRIX COMPOSITE FRICTION SURFACE PLATES

(76) Inventors: John T. Basirico, Ballston Lake, NY (US); Edward V. Bongio, Niskayuna, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/861,620

(22) Filed: Sep. 26, 2007

Related U.S. Application Data
(60) Provisional application No. 60/869,452, filed on Dec. 11, 2006.

(51) Int. Cl. F16D 65/12

(52) U.S. Cl. 188/218 XL

(57) ABSTRACT

The disclosure relates to structures and a method for providing an air cooled rotor with ceramic-metal composite friction surface plates, and in particular to a brake rotor including a rotor hat; a ventilation disc having a plurality of cooling vanes extending therefrom; a ceramic matrix composite (CMC) friction surface plate on each side of the ventilation disc; and a fastener for holding the CMC friction surface plates and the ventilation disc to the rotor hat.

This application claims the priority of U.S. Provisional Application No. 60/869,452, filed Dec. 11, 2006, under 35 USC 119(e), which is hereby incorporated by reference.

### BACKGROUND

1. Field of the Disclosure

The field of disclosure relates generally to braking components.

2. Related Art

Brake rotors are components of disc brake systems used in vehicles. Generally, brake rotors include a braking surface that is frictionally engaged by brake pads mounted on calipers. The size, weight, and other attributes of brake rotors are highly variable. Brake rotors are designed to provide adequate braking forces to control the vehicle. Also, brake rotors must be designed with an acceptable service life. A passenger vehicle, for example, typically utilizes relatively large and heavy brake rotors to provide the service life and braking forces required by such a vehicle.

Commonly used brake rotors are often manufactured from cast iron, which has acceptable hardness and wear resistance properties. However, cast iron has a relatively high material density compared to other materials. As a consequence, cast iron brake rotors are often heavy. Furthermore, a relatively large amount of energy is required to accelerate and decelerate the large, heavy, cast iron brake rotors that are found in most passenger vehicles. The weight of the rotors also increases the overall weight of the vehicle. Generally, excess weight negatively impacts handling and fuel economy.

For weight reduction, one approach utilizes lightweight metals, such as aluminum rotors with a ceramic coating, or a metal matrix composite. However, aluminum and other lightweight metals, when used as brake drums or rotors, often result in unacceptable performance, leading to unpredictable braking characteristics.

### SUMMARY

The disclosure relates to structures and a method for providing an air cooled rotor with ceramic matrix composite (CMC) friction surface plates, and in particular to a brake rotor including a rotor hat; a ventilation disc having a plurality of cooling vanes extending therefrom; a ceramic matrix composite (CMC) friction surface plate on each side of the ventilation disc; and a fastener for holding the CMC friction surface plates and the ventilation disc to the rotor hat.

One aspect of the disclosure is directed to a brake rotor comprising: a rotor hat; a ventilation disc having a plurality of cooling vanes extending therefrom; a ceramic matrix composite (CMC) friction surface plate on each side of the ventilation disc; and a fastener for holding the CMC friction surface plates and the ventilation disc to the rotor hat.

Another aspect of the disclosure is directed to a method to create a two-dimensional ceramic matrix composite (CMC), the method comprising: providing a plurality of heat treated fabric plies; saturating each ply using at least one of: a liquid pre-ceramic polymer or a silicon carbide slurry; forming a composite including several plies; hot pressing the composite to form a composite part; and densifying the composite part, including: infiltrating with the composite part with at least one of: the liquid pre-ceramic polymer and the silicon carbide slurry; and pyrolyzing the composite part to form ceramic matrix composite composed of carbon fibers and silicon carbide matrix.

### BRIEF DESCRIPTION OF THE DRAWINGS

The embodiments of this disclosure will be described in detail, with reference to the following figures, wherein like designations denote like elements, and wherein:

FIGS. 1-3 show embodiments of a brake rotor according to the disclosure.

FIGS. 4A-B show alternative embodiments of a ventilation disc for the brake rotor of FIGS. 1-3.

FIG. 5 shows a block diagram of embodiments of a method for creating a two-dimensional ceramic matrix composite according to the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

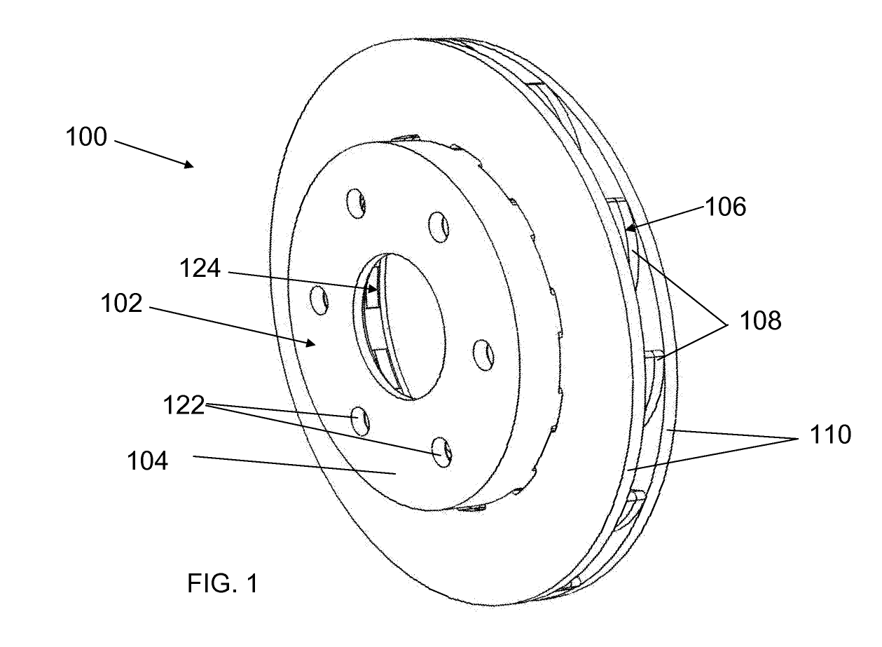

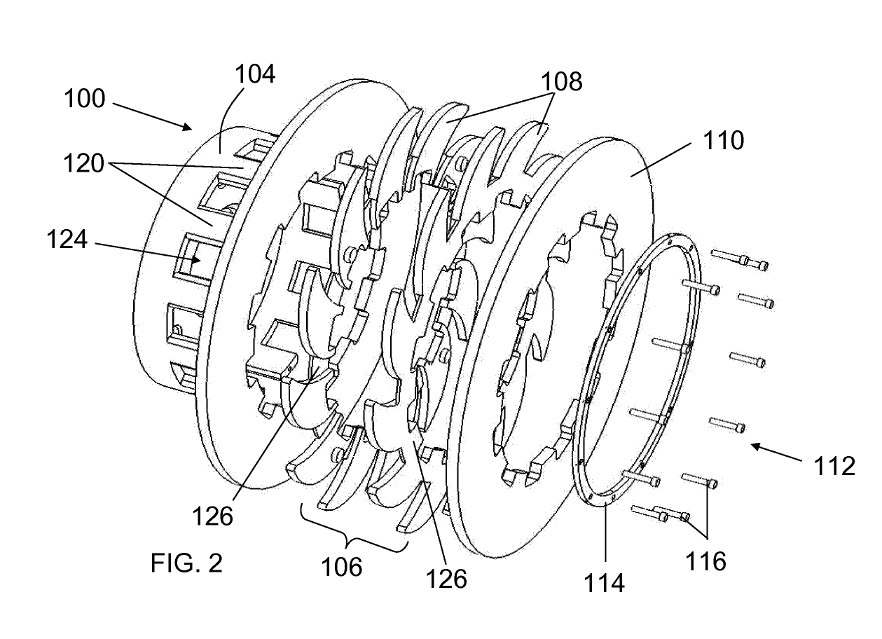

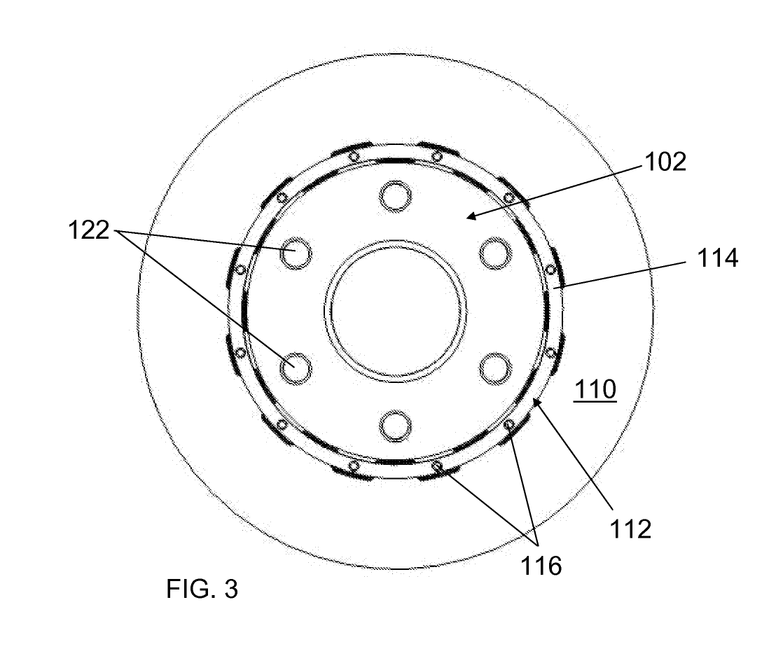

Turning to FIGS. 1-3, a brake rotor 100 according to embodiments of the disclosure is shown. Brake rotor 100 comprises: a rotor hat 102, a ventilation disc 106 having a plurality of cooling vanes 108 extending therefrom, a ceramic matrix composite (CMC) friction surface plate 110 on each side of ventilation disc 108, and a fastener 112 (FIGS. 2-3) for holding CMC friction surface plates 110 to rotor hat 102. During operation, rotor hat 102 attaches to an axle of, for example, an automobile, and provides venting and an attachment system for CMC friction surface plates 110. Fastener 112 is designed to hold CMC friction surface plates 110 with ventilation disc 106 therebetween against rotor hat 102. Each of these components and their operation will be described in further detail below.

As shown in FIGS. 1-3, rotor hat 102 includes a central hub 104 having a plurality of splines 120 extending therefrom. Splines 120 create venting openings 124 therebetween. Venting openings 124 promote the flow of cooling air through rotor hat 102, the openings between cooling vanes 108 and between CMC friction surface plates 110. By increasing the flow of air between CMC friction surface plates 110 and rotor hat 102, brake rotor 100 is more efficiently and rapidly cooled, leading to increased performance and endurance of brake rotor 100. Splines 120 and venting openings 124 can be designed in varying shapes and quantities, or be completely removed based on the application. In the embodiment shown, splines 120 extend through ventilation disc 106 and CMC friction surface plates 110, i.e., through complementary openings in disc 106 and plates 110. Materials for rotor hat 102 can be varied based on the demands of the application and include at least one of: CMC, metal matrix composite, carbon, low alloy steel, high alloy steel, ferrous alloy, aluminum, copper, magnesium, titanium, nickel and chromium-molybdenum alloy. As shown in FIGS. 1 and 3, a plurality of holes 122 and lug nuts (not shown) may be used to secure rotor hat 102 to an axle in any now known or later developed fashion. The number of holes 122 and lug nuts can be modified and is determined by the application.

As shown in FIGS. 1-3, brake rotor 100 has a CMC friction surface plate 110 on each side of ventilation disc 106. CMC friction surface plate 110 is the surface that makes contact with an automobile brake pad (not shown) during operation of a brake system including brake rotor 100. The use of the CMC material improves braking performance while reducing the weight of brake rotor 100 when compared to its metallic counterparts. The thickness of CMC friction plates 110 is dictated by its material properties and its application. However, in a preferred embodiment, the thickness of the CMC material is approximately 3/10 inches. Each ply may be 0.021 to 0.024 inches thick; however, this can vary with fabric type, weave, etc. Several options can be used for the material making up the CMC. The composite can be based on a two-dimensional lay up design, a chop molded compound material, felt preform, three-dimensional fabric preform or any combination of the four. The physical design of the CMC material takes into account the attachment method used for rotor hat 102. The method of fabrication may also vary, as further discussed below.

As also shown in FIGS. 1-2, in one embodiment, ventilation disc 106 has plurality of cooling vanes 108 extending from a hub 126. In one embodiment, cooling vanes 108 may include a CMC (e.g., chop molded) compound utilizing a high strength polyacrylonitrile (PAN) based carbon fiber and silicon carbide matrix. Materials for cooling vanes 108 can be varied based on the demands of the application and include at least one of: CMC, metal matrix composite, carbon, low alloy steel, high alloy steel, ferrous alloy, aluminum, copper, magnesium, titanium, nickel and chromium-molybdenum alloy. Cooling vanes 108 may be configured as elongated narrow protrusions that extend radially from hub 126 along the entire circumference of CMC friction surface plates 110. Cooling vanes 108 provide improved efficiency in moving air to cool brake rotor 100 by inducing airflow along the paths formed by the openings between each cooling vane 108. Furthermore, cooling vanes 108 act as heat sinks for CMC friction surface plates 110, since cooling vanes 108 are in abutting contact with CMC friction surface plates 110. The heat sink created by cooling vanes 108 combined with the airflow induced by venting openings 124 and cooling vanes 108 provides convective heat removal from brake rotor 100.

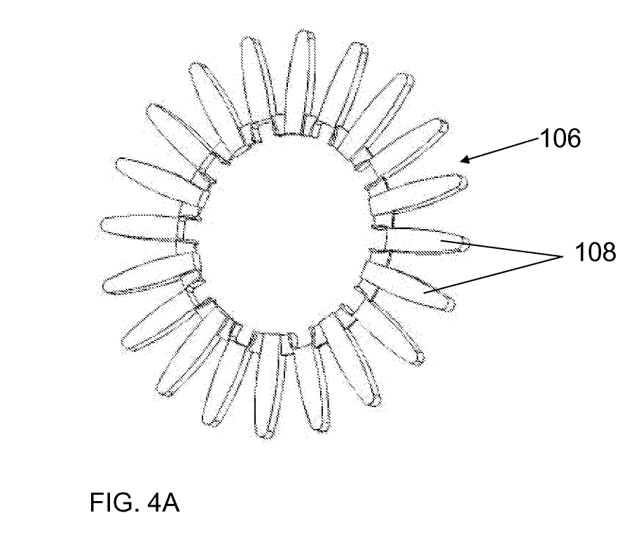

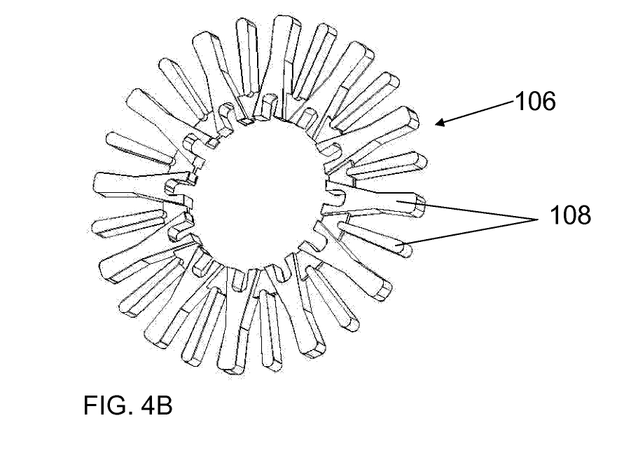

It should be appreciated that a number of cooling vane 108 configurations are possible without departing from the scope of the disclosure. In one embodiment, shown in FIGS. 1-2, cooling vanes 108 are substantially curved. In another embodiment, as shown in FIGS. 4A-B, cooling vanes 108 are substantially straight (may have angled or curved surfaces, and may have differently sized vanes). In alternative embodiments, cooling vanes 108 may be bonded to each of CMC friction surface plates 110, wherein the entire bonded structure is bolted or attached by splines 120 to rotor hat 102. Furthermore, in another alternative embodiment, ventilation disc 106 may be mechanically attached or bonded to rotor hat 102. However, mechanical attachment as illustrated allows rotor hat 102, ventilation disc 106 and CMC friction plates 110 to be more easily replaced. Having the ability to replace each part allows for easy modification of cooling vanes 108, CMC friction plates 110 and rotor hat 102 materials based on the application, e.g., commercial vehicles, racing vehicles, etc.

In one embodiment, cooling vanes 108 are integrally mechanically coupled to CMC friction surface plates 110 allowing for easy replacement of CMC friction surface plates 110. In another embodiment, cooling vanes 108 may be bonded to each of the CMC friction surface plates 110, wherein the entire bonded structure is bolted or attached by splines to rotor hat 102.

As shown in FIGS. 1-2, each CMC friction surface plate 110 is held to rotor hat 102 with ventilation disc 106 therebetween by fastener 112. In one embodiment, fastener 112 includes an attachment ring 114 holding CMC friction surface plates 110 with ventilation disc 106 therebetween to rotor hat 102 via bolts 116. In particular, bolts 116 screw into ends of splines 120 to hold attachment ring 114 against one of CMC friction plates 110, thus holding CMC friction plates 110 with ventilation disc 106 therebetween to rotor hat 102. As noted above, splines 120 extend through ventilation disc 106 and CMC friction surface plates 110, i.e., through complementary openings in disc 106 and plates 110, and are sized such that fastener 112 can hold CMC friction plates 110 and ventilation disc 106 to rotor hat 102. Other methods for attaching rotor hat 102, ventilation disc 106 and CMC friction surface plates 110 are possible. For example, although not shown, different spline 120 designs can be adapted for use with rotor hat 102. The geometry of splines 120 can be altered and the radius on the edges of the splines can be changed based on the application. Furthermore, an attachment ring 114 may be replaced by a non-ring structure or removed entirely such that bolts 116 clamp directly against an adjacent CMC friction plate 110. In another embodiment, splines 120 may extend beyond the outer CMC friction plate 110 and attachment ring 114 may thread onto a mating outer surface of splines 120.

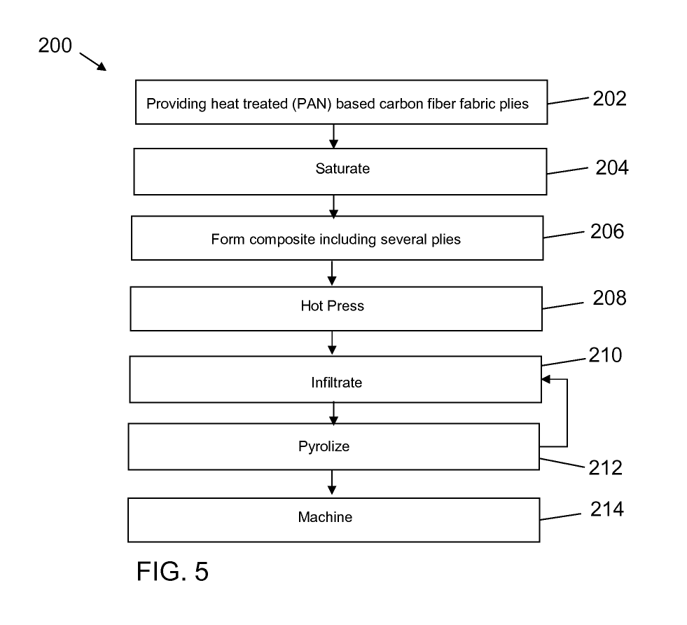

FIG. 5 shows a method 200 to create a two-dimensional CMC part using a hot/warm press with polymer infiltration and prolysis (PIP) cycling. Step 202 includes providing a plurality of heat treated fabric plies. The fabric plies may include, for example, a polyacrylonitrile (PAN) based material, pitch based carbon fibers, silicon carbide, a glass, an aramid and silicon oxycarbide. In step 204, each ply is saturated using a liquid pre-ceramic polymer and/or a silicon carbide slurry. The slurry may contain various amounts of filler materials to help form the initial silicon carbide matrix. After laying up the composite consisting of several plies (step 206), the composite is hot pressed under specific loading conditions and temperature regimes to form the composite part (step 208). For illustrative purposes only, the pressure may be, for example, 60 psi with a temperature of, for example, 650° C.; other parameters also possible. To densify the composite part, in step 210, the composite part is infiltrated with the liquid pre-ceramic polymer and/or the silicon carbide slurry. In step 212, the composite part is subsequently pyrolyzed to form silicon carbide. This is the PIP cycling process. Depending on the application, the PIP cycling process can be performed again by repeating steps 210 and 212. In one embodiment, PIP processing is complete after approximately 4-10 cycles. Method 200 achieves a two-dimensional CMC part that is approximately ¼ to ⅝ inches thick. Once the CMC part has reached the necessary density through PIP cycling, the composite part may be machined 214 to the desired shape, e.g., CMC friction plates 110. The CMC part can be used with, for example, brake rotor 100 as discussed above and shown in FIGS. 1-3. In this case, ventilation disc 106 (with cooling vanes 108) may be attached between a pair of CMC parts (i.e., friction plates 110) to rotor hat 102 to form brake rotor 100.

Other methods for forming the CMC part may include but are not limited to: melt infiltration, chemical vapor deposition (CVD) processing and chemical vapor infiltration (CVI). One method involves using a chop molded compound material. The chop molded compound material could be manufactured in a fashion similar to the two-dimensional composite. Where silicon carbide slurry is mixed with fibers placed in a mold and cured, once molded the part is densified using the above-described PIP processing.

Also, several different types of fabric weaves can be used in combination with different fibers and tow sizes. Fibers for the composite matrix may include, but are not limited to silicon carbide, silicon oxycarbide, silicon nitride, alumina and mullite. The fabric weave type may include, but is not limited to: plain, leno, satin weaves, twill, basket weave and crowfoot, while the fabric tow size is approximately 1000 to 24,000 carbon fiber filaments. In addition to using a 2-dimensional lay up procedure, a 3-dimensioanl preforms such as felts or 3-dimensional weaves could be utilized to form the CMC.

While this disclosure has been described in conjunction with the specific embodiments outlined above, it is evident that many alternatives, modifications and variations will be apparent to those skilled in the art. For example, it is evident that the present disclosure can be applied to automobiles, trains, military vehicles, aircraft, snowmobiles, all terrain vehicles, golf carts, go carts and race cars. Accordingly, the embodiments of the disclosure as set forth above are intended to be illustrative, not limiting. Various changes may be made without departing from the spirit and scope of the disclosure as defined in the following claims.

What is claimed is:

1. A brake rotor comprising:
a rotor hat;
a ventilation disc having a plurality of cooling vanes extending therefrom;
a ceramic matrix composite (CMC) friction surface plate on each side of the ventilation disc; and
a fastener for holding the CMC friction surface plates and the ventilation disc to the rotor hat.

2. The brake rotor of claim 1, wherein the rotor hat includes a plurality of splines extending through the ventilation disc and the CMC friction surface plates, and the fastener includes an attachment ring coupled to at least one of the plurality of splines.

3. The brake rotor of claim 1, wherein each cooling vane is substantially curved.

4. The brake rotor of claim 1, wherein each cooling vane is substantially straight.

5. The brake rotor of claim 1, wherein the ventilation disc includes a hub from which the cooling vanes extend, and a venting opening extending between adjacent cooling vanes.

6. The brake rotor of claim 5, wherein the hub includes one of: CMC, metal matrix composite, carbon, low alloy steel, high alloy steel, ferrous alloy, aluminum, copper, magnesium, titanium, nickel or chromium-molybdenum alloy.

7. The brake rotor of claim 1, wherein the cooling vanes include a CMC compound utilizing a high strength polyacrylonitrile (PAN) based carbon fiber and silicon carbide matrix.

8. The brake rotor of claim 1, wherein the ventilation disc includes a plurality of ventilation discs coupled together.

9. The brake rotor of claim 1, wherein the CMC friction surface plates are bonded to the ventilation disc.

10. The brake rotor of claim 1, wherein the rotor hat includes one of: CMC, metal matrix composite, carbon, low alloy steel, high alloy steel, ferrous alloy, aluminum, copper, magnesium, titanium, nickel or chromium-molybdenum alloy.

11. The method of claim 1, wherein the CMC friction surface plates are replaceable.

12. The method of claim 1, wherein the ventilation disc is replaceable.

13. A braking system comprising the brake rotor of claim 1.

14. A method to create a two-dimensional ceramic matrix composite (CMC) part, the method comprising:
providing a plurality of heat treated fabric plies;
saturating each ply using at least one of: a liquid pre-ceramic polymer and a silicon carbide slurry;
forming a composite including several plies;
hot pressing the composite to form the CMC part; and
densifying the CMC part by:
infiltrating the CMC part with at least one of: the liquid pre-ceramic polymer or the silicon carbide slurry; and
pyrolyzing the CMC part to form a ceramic matrix composite composed of carbon fibers and silicon carbide matrix.

15. The method of claim 14, further comprising repeating the densifying.

16. The method of claim 14, further comprising machining the CMC part to form a brake rotor.

17. The method of claim 16, further comprising attaching a ventilation disc between a pair of the CMC parts to a rotor hat, the ventilation disc having a plurality of cooling vanes extending therefrom.

18. The method of claim 16, wherein the heat treated fabric plies includes a material selected from the group consisting of: a polyacrylonitrile (PAN) based material, pitch based carbon fibers, silicon carbide, a glass, an aramid and silicon oxycarbide.
